(19) United States
(12) Patent Application Publication
(10) Pub. No.: US 2013/0068916 A1
(43) Pub. Date: Mar. 21, 2013

(54) RECLINING STAND SYSTEM AND METHOD

(71) Applicants: Jeffrey Mensing, Plymouth, MN (US); Mustafa A. Ergun, Plymouth, MN (US); Shaun C. Lindblad, Lino Lakes, MN (US)

(72) Inventors: Jeffrey Mensing, Plymouth, MN (US); Mustafa A. Ergun, Plymouth, MN (US); Shaun C. Lindblad, Lino Lakes, MN (US)

(73) Assignee: ERGOTRON, INC., Eagan, MN (US)

(21) Appl. No.: 13/422,387

(22) Filed: Mar. 16, 2012

Related U.S. Application Data
(60) Provisional application No. 61/453,393, filed on Mar. 16, 2011.
(60) Provisional application No. 61/590,071, filed on Jan. 24, 2012.

(51) Int. Cl. F16M 11/00

(52) U.S. Cl. 248/558; 248/121; 248/122.1

(57) ABSTRACT

A stand useful for supporting one or more electronic displays. A stand useful for allowing one or more displays to be positioned at a wide variety of angles relative to a support surface. A stand that allows for the displays to be positioned at relatively extreme inclined angles. A stand useful for allowing an electronic display to be positioned closer to or away from a user while the angle is being adjusted. Methods of using such stands.

### RELATED APPLICATIONS

This application claims the benefit of U.S. Provisional Application Ser. No. 61/453,393, entitled Display Stand System and Method, filed Mar. 16, 2011, and U.S. Provisional Application Ser. No. 61/590,071, entitled Stand System and Method, filed Jan. 24, 2012, the contents of each of which are hereby incorporated by reference.

### FIELD

The invention generally relates to systems and methods for reclining stands useful for positioning electronic devices.

### BACKGROUND

Electronic displays, including tablet computing devices, are useful for viewing and entering information. Stands for electronic displays are useful for positioning the displays.

### SUMMARY

Embodiments of the invention generally relate to stands useful for supporting one or more electronic displays (such as an LCD screen or monitor, or a tablet computer, which can be considered an “electronic display” for purposes of this application). In some embodiments, the stands are useful for allowing one or more displays to be positioned at a wide variety of angles relative to a support surface, such as a horizontal desk. In certain embodiments, the stands allow for the displays to be positioned at relatively extreme inclined angles (e.g., more than 20 degrees off vertical to near or past horizontal). Further, embodiments of the stand are useful for allowing an electronic display to be positioned closer to or away from a user while the angle is being adjusted. In certain embodiments, a user's single motion is operable to both adjust the tilt angle of a display about a horizontal axis and position the display toward or away from a user along a horizontal axis perpendicular to the tilt angle axis. In general, the single motion is also operable to adjust the height of the electronic display relative to the support surface. Such embodiments are useful for providing a single stand that can position an electronic display in a generally vertical and elevated position and a generally reclined and lower position, and any position between these two positions.

### BRIEF DESCRIPTION OF THE DRAWINGS

The following drawings are illustrative of particular embodiments of the invention and therefore do not limit the scope of the invention. The drawings are not necessarily to scale (unless so stated) and are intended for use in conjunction with the explanations in the following detailed description. Embodiments of the invention will hereinafter be described in conjunction with the appended drawings, wherein like numerals denote like elements.

FIG. 1A is a perspective view of a stand in accordance with an embodiment of the invention in a generally vertical position;

FIG. 1B is a perspective view of a stand in accordance with an embodiment of the invention in a generally reclined position;

FIG. 2A is a perspective view of a stand in accordance with an embodiment of the invention with an electronic display in a generally vertical position;

FIG. 2B is a perspective view of a stand in accordance with an embodiment of the invention with an electronic display in a generally reclined position;

FIG. 3A is a side view of a stand in accordance with an embodiment of the invention with an electronic display in a generally vertical position;

FIG. 3B is a side view of a stand in accordance with an embodiment of the invention with an electronic display in a generally reclined position;

FIG. 4A is a side view of a stand in accordance with an embodiment of the invention in a generally vertical position;

FIG. 4B is a side view of a stand in accordance with an embodiment of the invention in a generally reclined position;

FIG. 5 is a partially transparent side view of a stand in accordance with an embodiment of the invention in an intermediate position;

FIG. 6A is a partially transparent side view of a stand in accordance with an embodiment of the invention in a generally vertical position;

FIG. 6B is a partially transparent side view of a stand in accordance with an embodiment of the invention in a generally reclined position;

FIG. 7A is a perspective view of a stand in accordance with an embodiment of the invention;

FIG. 7B is a partially transparent perspective view of a stand in accordance with an embodiment of the invention;

FIG. 7C is a rear perspective view of a stand in accordance with an embodiment of the invention;

FIG. 8A is a perspective view of a stand in accordance with an embodiment of the invention in a generally vertical position;

FIG. 8B is a perspective view of a stand in accordance with an embodiment of the invention in a generally reclined position;

FIG. 9A is a perspective view of a stand in accordance with an embodiment of the invention with an electronic display in a generally vertical position;

FIG. 9B is a perspective view of a stand in accordance with an embodiment of the invention with an electronic display in a generally reclined position;

FIG. 10A is a side view of a stand in accordance with an embodiment of the invention with an electronic display in a generally vertical position;

FIG. 10B is a side view of a stand in accordance with an embodiment of the invention with an electronic display in a generally reclined position;

FIG. 11A is a side view of a stand in accordance with an embodiment of the invention in a generally vertical position;

FIG. 11B is a side view of a stand in accordance with an embodiment of the invention in a generally reclined position;

FIG. 11C is a partially transparent side view of a stand in accordance with an embodiment of the invention;

FIG. 12A is a partially transparent perspective view of a stand in accordance with an embodiment of the invention;

FIG. 12B is a partially transparent perspective view of a stand in accordance with an embodiment of the invention;

FIG. 13A is a perspective view of a stand with independent height adjustment shown in a first position in accordance with an embodiment of the invention;

FIG. 13B is a perspective view of a stand with independent height adjustment shown in a second position in accordance with an embodiment of the invention;

FIG. 14A is a rear perspective view of a stand with independent height adjustment in accordance with an embodiment of the invention;

FIG. 14B is a rear perspective view of a stand with a locking mechanism in accordance with an embodiment of the invention;

FIG. 15A is a rear perspective view of a stand with independent height adjustment in accordance with an embodiment of the invention;

FIG. 15B is a rear perspective view of a stand with a locking mechanism in accordance with an embodiment of the invention;

FIG. 16A is a perspective view of a locking mechanism in accordance with an embodiment of the invention;

FIG. 16B is a perspective view of a locking mechanism in accordance with an embodiment of the invention;

FIG. 16C is a rear perspective view of a locking mechanism in accordance with an embodiment of the invention;

FIG. 17A is a perspective view of a locking mechanism in accordance with an embodiment of the invention;

FIG. 17B is a perspective view of a locking mechanism in accordance with an embodiment of the invention;

FIG. 18A is a side view of a stand in accordance with an embodiment of the invention with an electronic display in a generally vertical position;

FIG. 18B is a side view of a stand in accordance with an embodiment of the invention with an electronic display in a generally reclined position;

FIG. 19A is a side view of a stand in accordance with an embodiment of the invention;

FIG. 19B is an embodiment of a view of cross-section A-A of FIG. 19A;

FIG. 19C is an embodiment of a view of cross-section A-A of FIG. 19A;

FIG. 19D is an embodiment of a view of cross-section A-A of FIG. 19A;

FIG. 19E is an embodiment of a view of cross-section A-A of FIG. 19A;

FIG. 20 is a rear perspective view of a stand in accordance with an embodiment of the invention;

FIG. 21A is a side view of a stand in accordance with an embodiment of the invention with an electronic display in a generally vertical position;

FIG. 21B is a side view of a stand in accordance with an embodiment of the invention with an electronic display in a generally reclined position;

FIG. 22A is a side view of a stand in accordance with an embodiment of the invention with an electronic display in a generally vertical position;

FIG. 22B is a side view of a stand in accordance with an embodiment of the invention with an electronic display in a generally reclined position;

FIG. 23A is a side view of a stand in accordance with an embodiment of the invention with an electronic display in a generally vertical position; and

FIG. 23B is a side view of a stand in accordance with an embodiment of the invention with an electronic display in a generally reclined position.

### DETAILED DESCRIPTION OF THE PREFERRED EMBODIMENTS

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

Embodiments of a stand are useful for positioning an electronic display in a desired position, such as a generally vertically elevated position relatively away from a user oriented in a generally vertical plane and a generally reclined position relatively close to the user oriented in a generally reclined plane. For purposes of this disclosure, “generally vertical” means vertical and plus or minus 20 degrees from vertical. Also for purposes of this disclosure, “generally reclined” means an angle of more than about 20 degrees from vertical (a “recline angle”), such a recline angle of at least 40 degrees from vertical . In some embodiments, the recline angle is at least 50 degrees from vertical. In yet other embodiments, the recline angle is at least 60 degrees from vertical (e.g., about 70 degrees). In certain embodiments, the recline angle is at least about 90 degrees from vertical such that the stand holds the electronic display in a fully horizontal position. In some embodiments, the user can easily position the electronic display between the two positions, and any intermediate position between the two positions, easily, with one hand and in one motion.

For purposes of this disclosure, “electronic displays” include monitors, such as LCD/LED screens, and tablet computing devices, sometimes referred to as tablets or tablet computers. Tablets are generally planar, lightweight devices that include a touch-screen display. Examples presently available include the Apple iPad, Kindle Fire, Motorola Xoom, Samsung Galaxy, Blackberry Playbook, LG Optimus Pad, Dell Streak, HP TouchPad, HTC Flyer, and Viewsonic ViewPad. Generally, tablets have a rectangular form factor about 20 CM to about 30 CM in length, about 10 CM to about 20 CM in height, and about 1 CM in thickness or less, with a weight of between about 400 grams and about 1 KG. Tablets also generally have a LCD or TFT display panel with a screen size of between about 15 CM and about 25 CM, between about 500 MB and 1 GB of RAM, front and/or rear camera(s), about 16 GB to about 64 GB of storage, usually at least one proprietary connector and/or HDMI and/or USB input/output, audio and charging inputs/outputs, and 3G/4G and Wi-Fi network connections. Of course, other exemplary tablets may be, or may come, available having one or more characteristics outside of the ranges provided above.

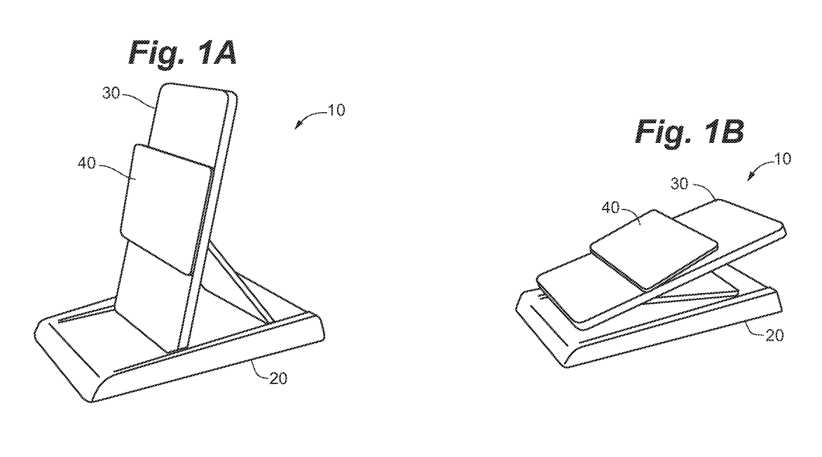

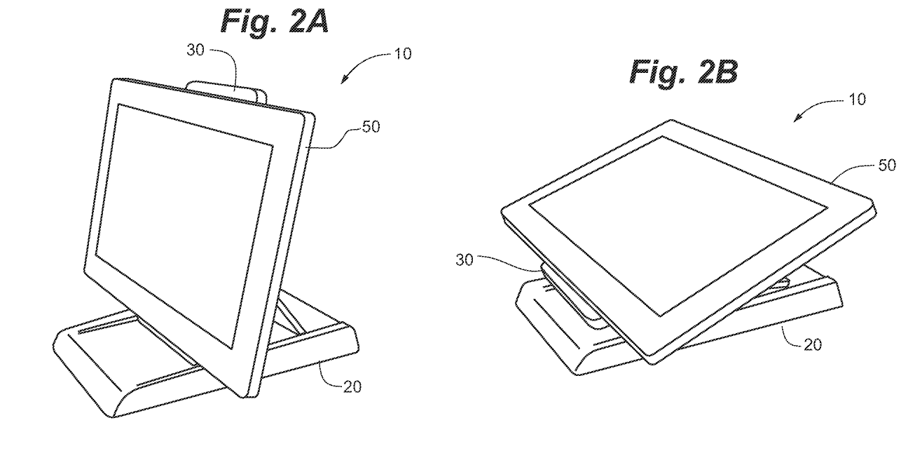

A first embodiment of a stand 10 in accordance with the invention is shown in FIGS. 1A-7C. FIG. 1A shows the stand 10 in a generally vertical position, while FIG. 1B shows the stand 10 in a generally reclined position. As shown, the stand 10 includes a base 20 adapted to rest on, or optionally be attached to, a horizontal surface. A riser 30 supporting a mounting bracket 40 adapted to support an electronic display extends from the base 20. FIG. 2A shows an exemplary electronic display 50 supported by the stand 10 in the generally vertical position, while FIG. 2B shows the electronic display 50 supported by the stand 10 in a generally reclined position.

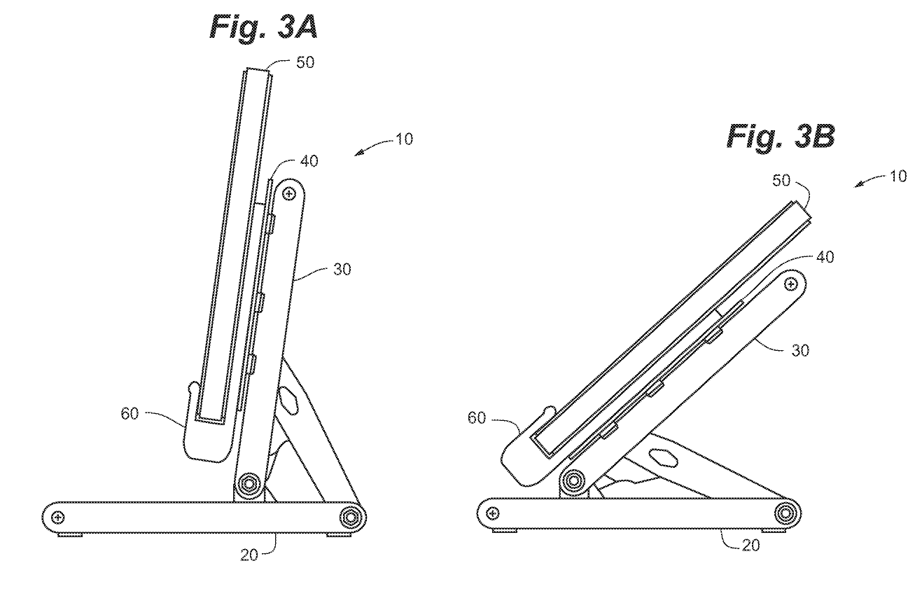

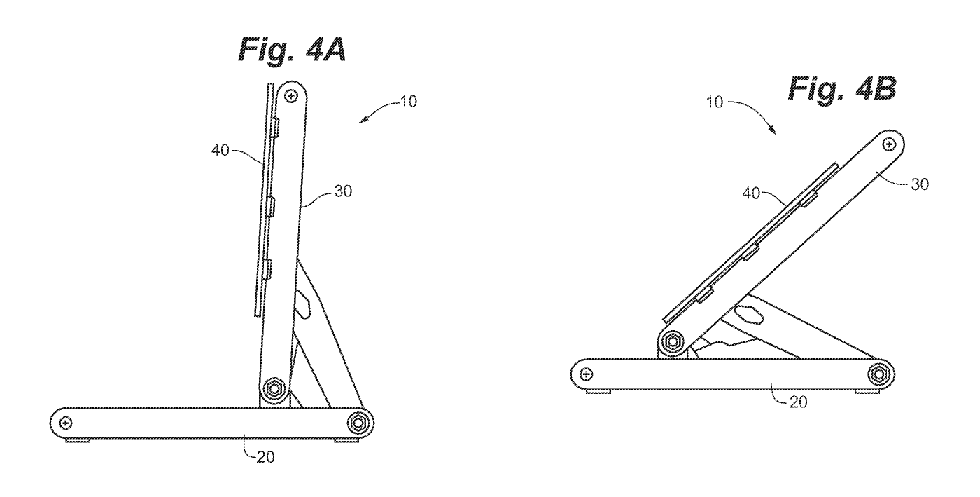

FIG. 3A shows the stand 10 with an electronic display 50 in the generally vertical position. In the embodiments shown, the electronic display 50 includes a tablet, connected to the mounting plate 40 via a tablet holder 60 (optionally a docking station) having an edge to support the tablet. FIG. 3B shows the stand 10 of FIG. 3A in a generally reclined position. As shown, the stand positions the electronic display 50 both at a reclined angle and closer to a user in the reclined position. FIG. 4A shows a side view of the stand 10 in a generally vertical position, while FIG. 4B shows the stand 10 in a generally reclined position.

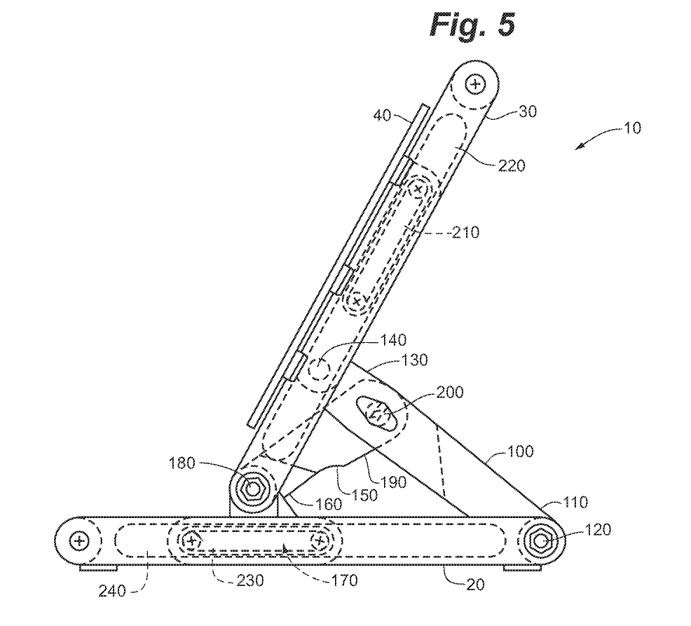

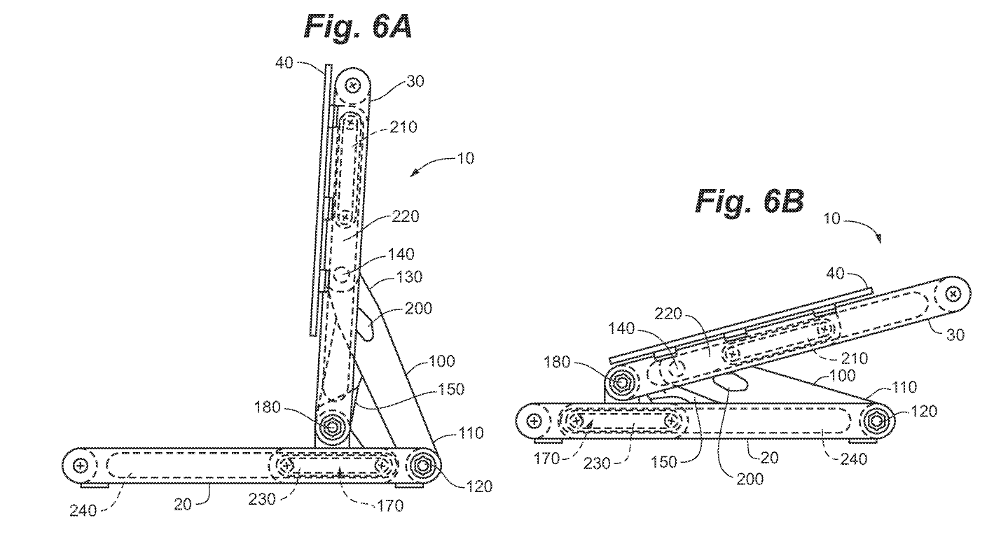

FIG. 5 shows the stand 10 in an intermediate position between the vertical position and the reclined position. In some embodiments, the stand 10 is positionable at any angle between the vertical position and the reclined position. For clarity, in FIG. 5 some components of the stand are depicted as transparent. FIG. 6A shows the partially transparent depiction of the stand of FIG. 5 in a generally vertical position, and FIG. 6B shows the stand in a generally reclined position.

As shown in one or more of FIGS. 5-6B, the stand 10 can include a first link 100 having a first end 110 pivotably coupled to the base 20 at a first pivot 120 and a second end 130 pivotably coupled to the mounting bracket 40 at a second pivot 140. In some embodiments, the first pivot 120 is a fixed pivot such that its pivot axis does not move with respect to the base 20 during angular adjustments of the stand, and the second pivot 140 is a movable pivot, such that its pivot axis moves with respect to the riser 30 during angular adjustments of the stand. Also as shown, the stand can include a second link 150 having a first end 160 pivotably coupled to a sliding bracket 170 at a third pivot 180 and a second end 190 pivotably coupled to the first link 100 at a fourth pivot 200. In certain embodiments, the third pivot 180 is a moveable pivot such that its pivot axis moves with respect to the base 20 during angular adjustments of the stand, and the fourth pivot 200 is a movable pivot that moves along with the first link 100 during angular adjustments of the stand. In certain embodiments, the sliding bracket 170 is slidable with respect to the base 20. In should be noted that some embodiments of the stand 10 include two sets of each of these components, such as in a generally symmetrical configuration with respect to a vertical plane. Further, as described below, at least one spring (not depicted in FIGS. 5-6B) can be positioned to balance a torque that is applied to the riser 30 by the electronic display at the generally vertical position, the generally reclined position, and at any angle between the generally vertical position and generally reclined position. Such a balancing force is useful for holding a desired position of the stand.

The mounting bracket 40 can be slidably connected to the riser 30 in a manner that allows it to move with respect to the riser by any suitable arrangement. For example, the mounting bracket can include at least one mounting bracket pin 210 received within a slot 220 in the riser. The pin articulates within the slot in response to an angular change of the stand (e.g., riser). Also, the sliding bracket 170 can be slidably connected to the base 20 in a manner that allows it to move with respect to the base by any suitable arrangement. For example, the sliding bracket can include at least one sliding bracket pin 230 received within a base slot 240 in the base. The pin articulates within the slot in response to an angular change of the stand.

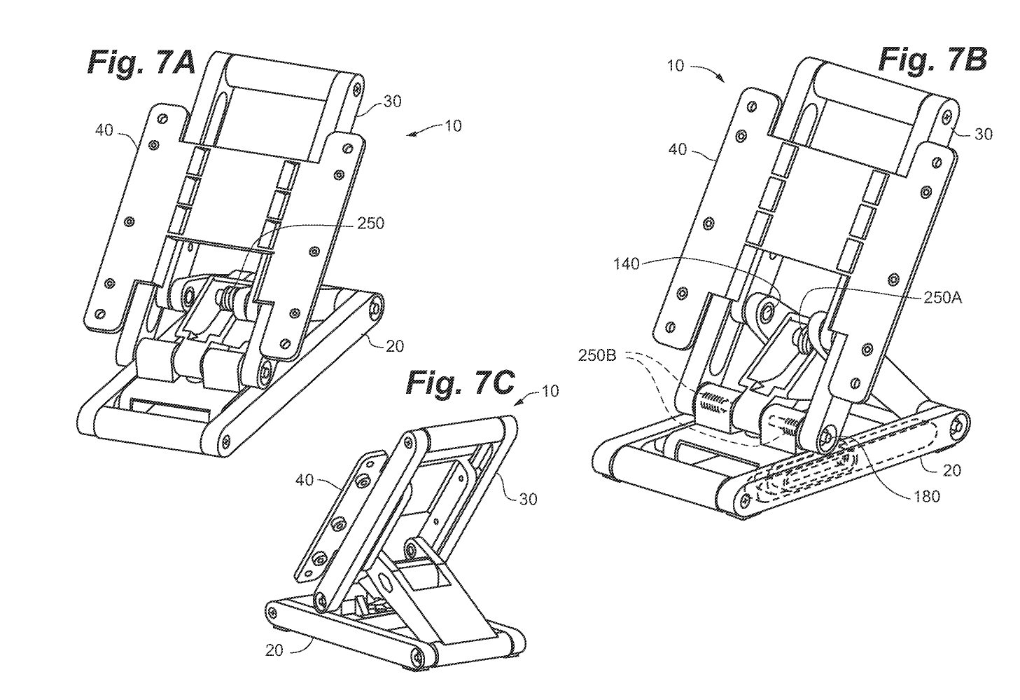

FIGS. 7A-C show perspective views of the embodiment of the stand. FIG. 7B depicts various components as transparent for a better view of the inner workings of the stand 10. In the embodiment shown, at least one spring 250 is operable about at least one of the first, second, third, and fourth pivots. As shown best in FIG. 7B, the at least one spring can include a first spring 250A operable about the second pivot 140 and a second spring 250B operable about the third pivot 180. In the depicted embodiments, the first spring and the second spring are torsion springs. The spring(s) are operable to provide a counteracting force to hold the display in a generally vertical position, a generally reclined position, and any intermediate position between the generally vertical and reclined positions.

In the embodiment shown, the riser 30 is angularly adjustable with respect to the base 20 from a generally vertical position to a generally reclined position and the mounting bracket 40 moves along a length of the riser in response to an angular adjustment. In such an embodiment, a user can recline an electronic display supported by the stand and in a single motion change the angle of the electronic display and change the relative position of the electronic display with respect to the riser.

In use, a user can grasp an electronic display supported by the stand to change the angle and position of the electronic display relative to the base of the stand. The forces applied by the user will be transmitted to the riser via the mounting bracket. The user may also directly apply a force to the riser. In either case, the force will adjust the angle of the riser and will cause the mounting bracket to mover with respect to the riser and the sliding bracket to move with respect to the base via the movement of the first and second links and rotation about the first, second, third, and fourth pivots.

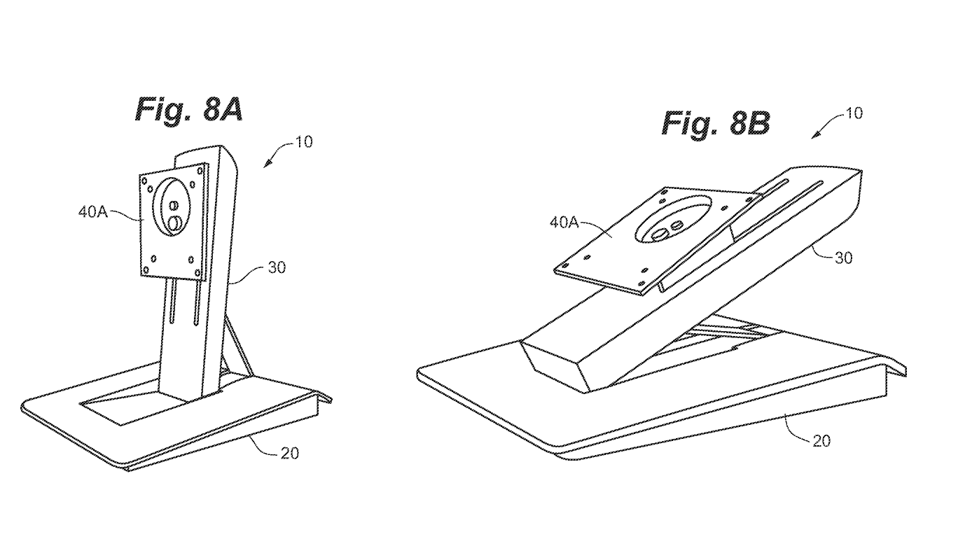

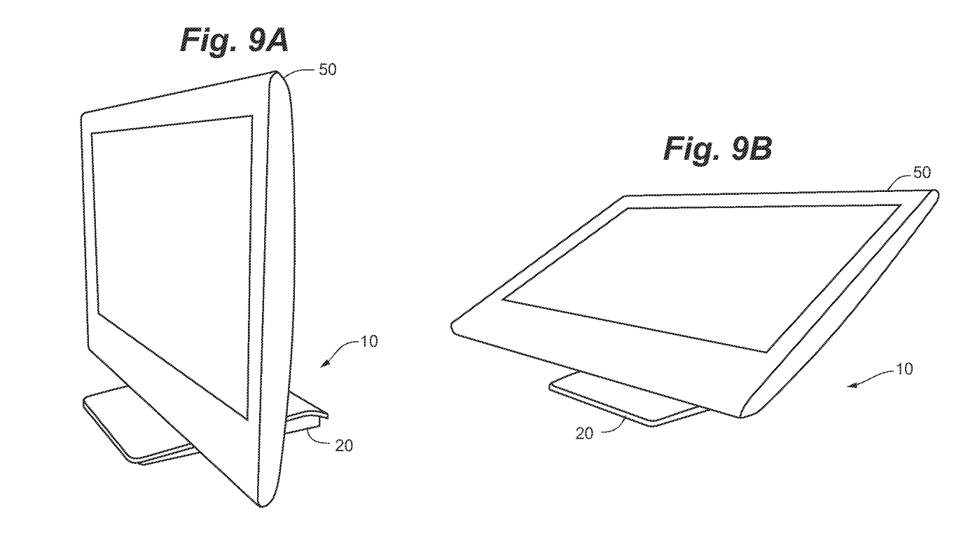

A second embodiment of a stand 10 in accordance with the invention is shown in FIGS. 8A-17B. FIG. 8A shows the stand 10 in a generally vertical position, and FIG. 8B shows the stand 10 in a generally reclined position. As shown, the stand includes a base 20 adapted to rest on, or optionally be attached to, a horizontal surface. A riser 30 supporting a mounting bracket 40 (obscured from view by screen mount 40A) adapted to support an electronic display extends from the base 20. FIG. 9A shows an electronic display 50 supported by the stand 10 in a generally vertical position, and FIG. 9B shows the electronic display 50 supported by the stand 10 in a generally reclined position.

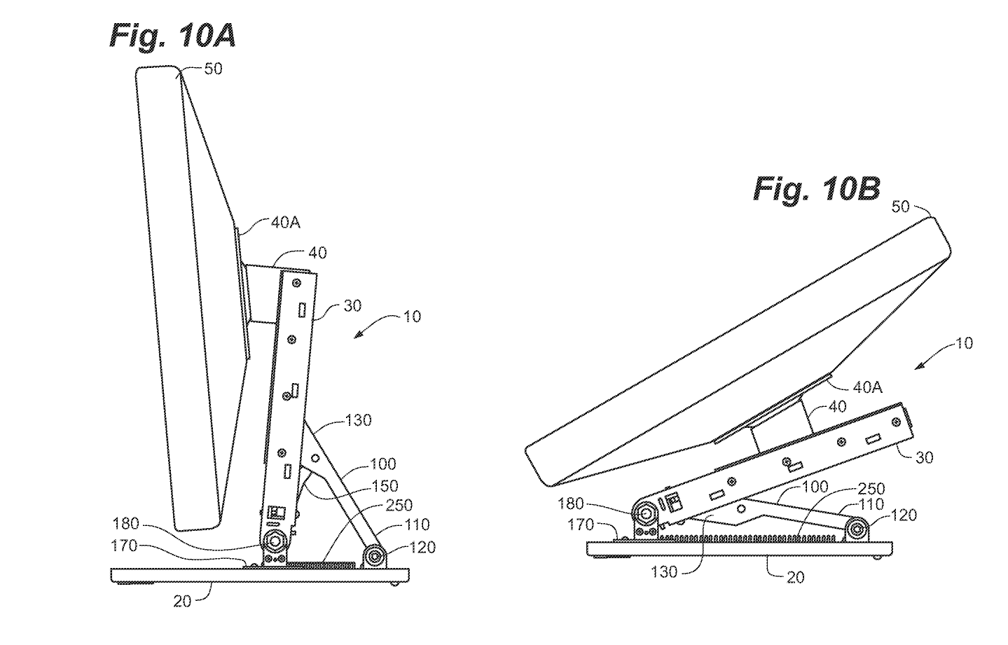

FIG. 10A shows the stand 10 with an electronic display 50 in the generally vertical position. In the embodiment shown, the electronic display includes a screen, connected to the mounting plate 40 via a screen mount 40A (optionally including independent tilt, pan, and/or portrait/landscape adjustments). FIG. 10B shows the stand 10 of FIG. 10A in a generally reclined position. As shown, the stand positions the electronic display 50 both at a recline angle and closer to a user in the reclined position. In some embodiments, the stand is positionable at any angle between the vertical position and the reclined position.

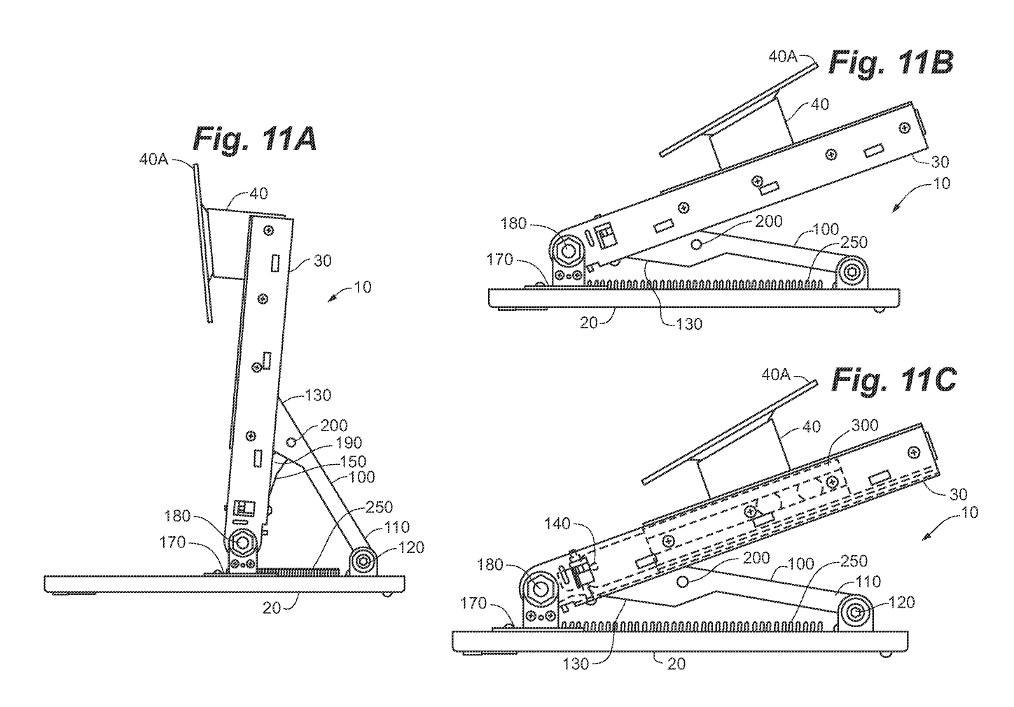

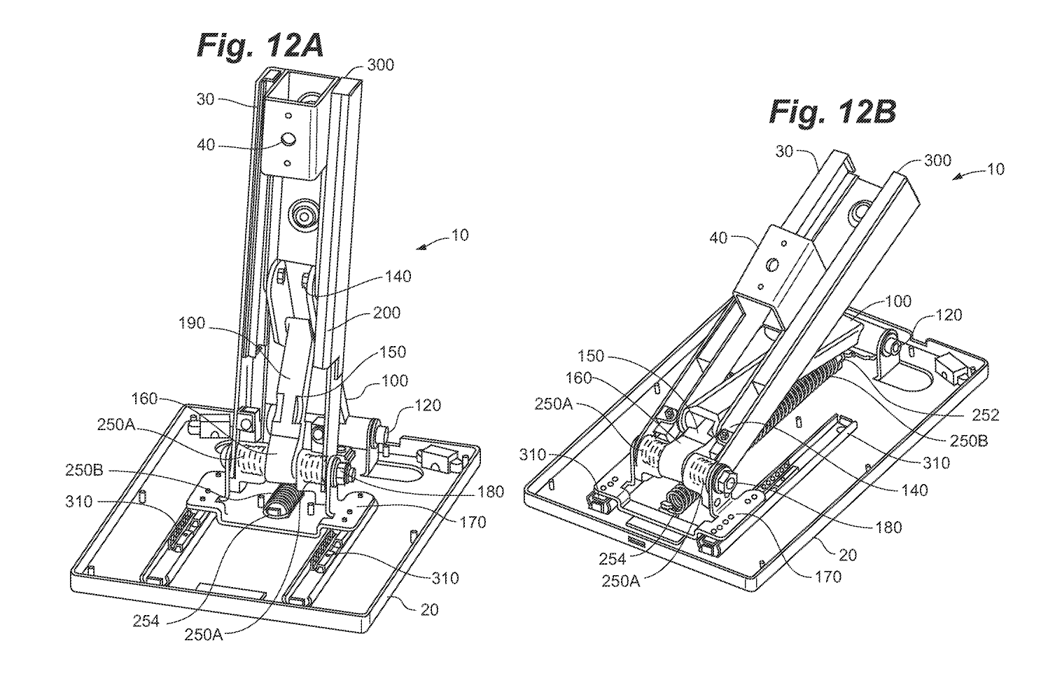

FIG. 11A shows a side view of the stand 10 in a generally vertical position, while FIG. 11B-C shows the stand 10 in a generally reclined position. For clarity, in FIG. 11C some components of the stand are depicted as transparent. FIGS. 12A and 12B include perspective views of the stand, again with some components depicted as transparent to better view the inner workings of the stand.

As shown in one or more of FIGS. 10A-12B, the stand 10 can include a first link 100 having a first end 110 pivotably coupled to the base 20 at a first pivot 120 and a second end 130 pivotably coupled to the mounting bracket 40 at a second pivot 140. In some embodiments, the first pivot 120 is a fixed pivot such that its pivot axis does not move with respect to the base 20 during angular adjustments of the stand, and the second pivot 140 is a movable pivot, such that its pivot axis moves with respect to the riser 30 during angular adjustments of the stand. Also as shown, the stand can include a second link 150 having a first end 160 pivotably coupled to a sliding bracket 170 at a third pivot 180 and a second end 190 pivotably coupled to the first link 100 at a fourth pivot 200. In certain embodiments, the third pivot 180 is a moveable pivot such that its pivot axis moves with respect to the base during angular adjustments of the stand, and the fourth pivot 200 is a movable pivot that moves along with the first link 100 during angular adjustments of the stand. In certain embodiments, the sliding bracket 170 is slidable with respect to the base 20. Further, at least one spring 250 is positioned to balance a torque that is applied to the riser by the electronic display at the generally vertical position, the generally reclined position, and any angle between the generally vertical position and generally reclined position. Such a balancing force is useful for holding a desired position of the stand.

As best shown in FIG. 11C, the mounting bracket 40 can be slidably connected to the riser 30 in a manner that allows it to move with respect to the riser by any suitable arrangement. For example, the mounting bracket can be coupled to the riser via at least one slide 300, the at least one slide having a first portion coupled to the mounting bracket and a second portion coupled to the riser, the first and second portions being slidable with respect to each other.

As shown best in FIG. 12A-B, the sliding bracket 170 can be slidably connected to the base 20 in a manner that allows it to move with respect to the base by any suitable arrangement. For example, the sliding bracket can be coupled to the base via at least one slide 310, the at least one slide having a first portion coupled to the sliding bracket and a second portion coupled to the base, the first and second portions being slidable with respect to each other. As shown, two at least one slides 310 may be utilized.

Also as shown best in FIGS. 12A-B, the at least one spring 250 can include a first end 252 coupled to the base 20 and a second end 254 coupled to the sliding bracket 170. Such a spring 250 can include an extension spring. In some embodiments, the at least one spring includes a first spring 250A operable about one of the first, second, third, or fourth pivots and a second spring 250B having a first end 252 coupled to the base 20 and a second end 254 coupled to the sliding bracket 170. In such embodiments, the first spring 250A can include a torsion spring and the second spring 250B can include an extension spring. The spring(s) are operable to provide a balancing force to hold an electronic display in a generally vertical position, a generally reclined position, and any intermediate position between the generally vertical and reclined positions.

In the embodiment shown, the riser is angularly adjustable with respect to the base from a generally vertical position to a generally reclined position and the mounting bracket moves along a length of the riser in response to an angular adjustment. In such an embodiment, a user can recline an electronic display supported by the stand and in a single motion change the angle of the electronic display and change the relative position of the electronic display with respect to the riser.

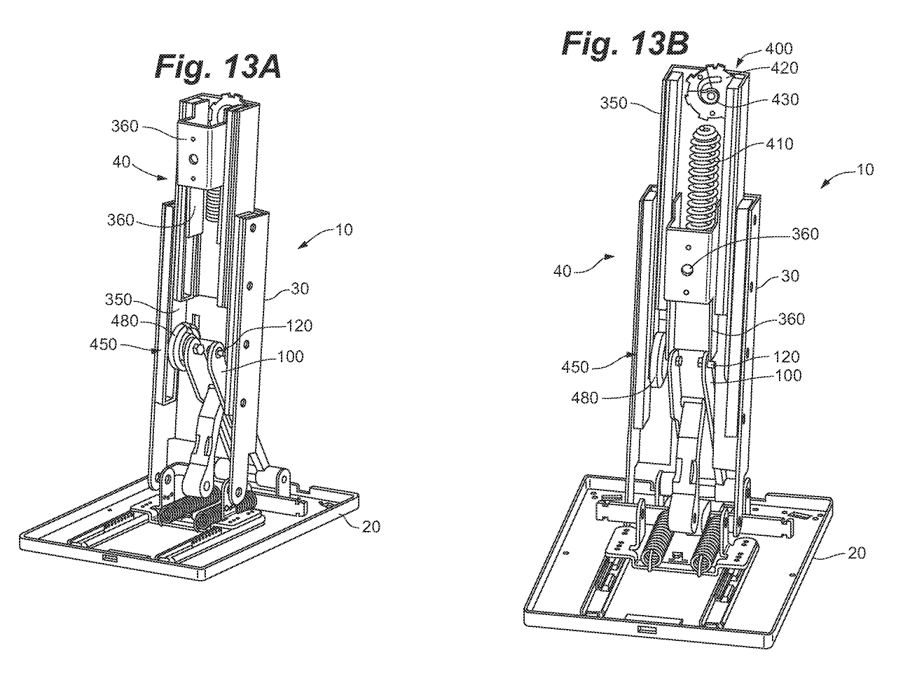

An embodiment of a stand 10 with independent height adjustment to adjust the height of the mounting bracket with respect to the riser independently of adjustment of the recline angle is shown in FIGS. 13A-17B. In the discussion below, the independent height adjustment is shown on a stand embodiment substantially the same as the stand embodiment discussed immediately above. However, it should be understood that independent height adjustment can be provided on other stand embodiments, such the embodiments discussed with respect to FIGS. 1A-7C. As shown in FIGS. 13A-B, in such embodiments the mounting bracket 40 can include a first portion 350 coupled to the first link 100 about the first pivot 120 (which operates as described above), and a second portion 360 adapted to carry the electronic display independently adjustable with respect to the first portion 350. FIG. 13A depicts the second portion at a generally upward position with respect to the first portion, and FIG. 13B depicts the second portion at a generally downward position with respect to the first portion.

As shown best in FIG. 13B, a counterbalancing mechanism 400 can be connected between the first portion 350 and the second portion 360. The counterbalancing mechanism can include any arrangement useful for providing a counterbalancing force to allow the electronic display to be positioned at any position relative to the riser 30 within a range of positions allowed by the stand 10 without any locks or detents to fix the position. As shown, in some embodiments, the counterbalancing mechanism includes a spring 410 (e.g., an extension spring) ultimately coupled to the base 20 and to a wheel 420 via a rope (not shown), the wheel including a cam 430 coupled to the second portion via a second rope (not shown). Additional details of such a counterbalancing mechanism are described in US Pub. No. 2010/0176,254, titled Lift Mechanism Systems and Methods, published Jul. 15, 2010, and assigned to Ergotron, Inc., the relevant contents of which are hereby incorporated by reference.

In some embodiments, the first portion 350 of the mounting bracket 40 is adjustable with respect to the second portion 360 of the mounting bracket 40 only when the riser 30 is in a generally vertical position. In the embodiment shown in FIGS. 13A-B, the first portion 350 is pivotably connected to the first link 100 about the first pivot 120 via a locking system 450 operable to allow the independent adjustment of the first portion only when the riser is in the generally vertical position, and prohibit independent adjustment when the riser is in any other angular position.

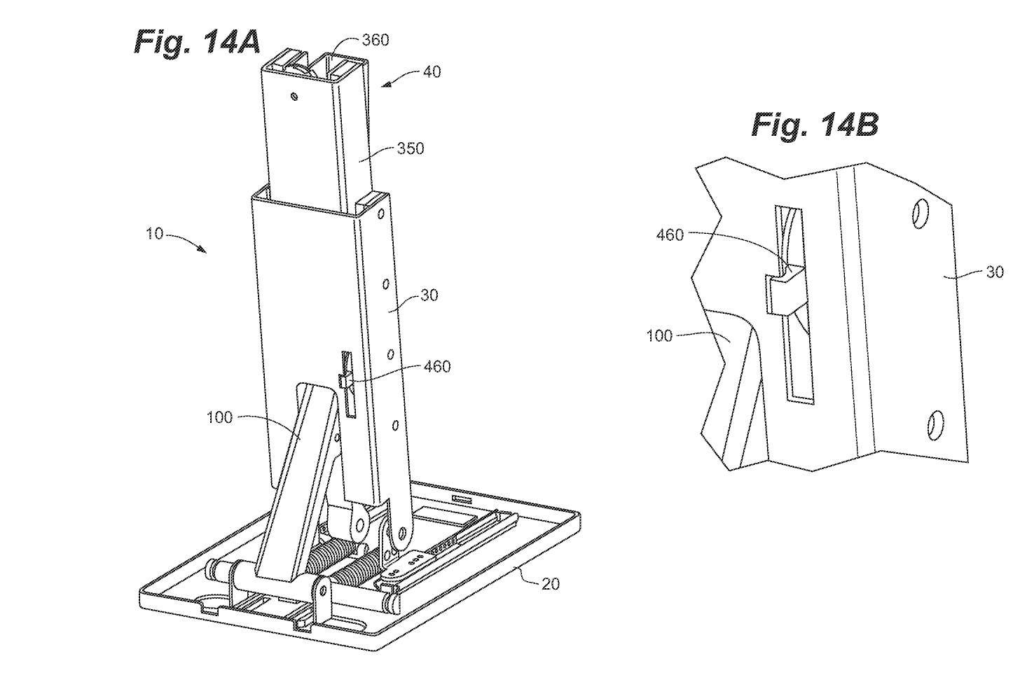

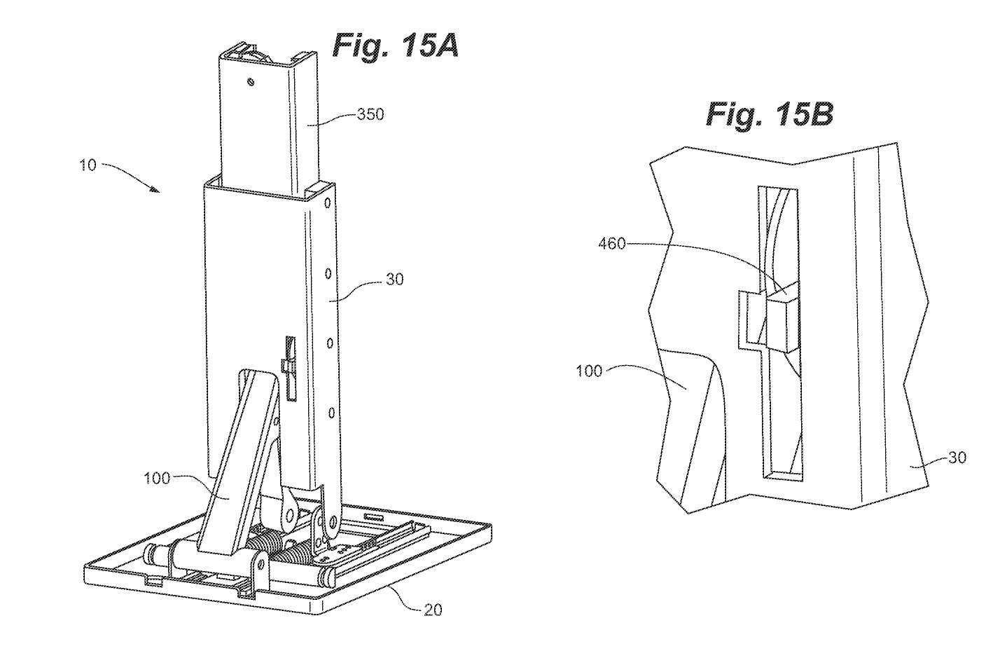

In the embodiment shown, the locking mechanism 450 includes a lock tab that fixes the position of the first link with respect to the riser 30, and thereby prevents angular adjustment, when in a locked position, and allows the first link to pivot about the second pivot with respect to the riser when in the unlocked position. In such embodiments, moving the electronic display to its generally vertical position is operable to lock the angle of the riser with respect to the base. In FIG. 14A, second portion 360 is adjusted upwardly and tab 460 is in its locked position. A larger view of tab 460 in its locked position is shown in FIG. 14B. In FIG. 15A, second portion 360 is adjusted downwardly and tab 460 is in its unlocked position. A larger view of tab 460 in its unlocked position is shown in FIG. 15B.

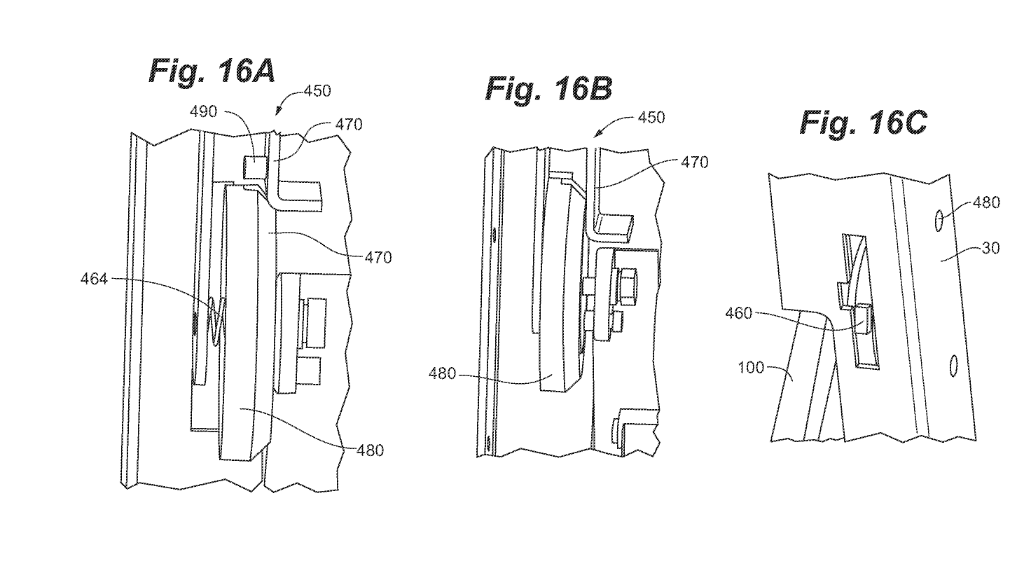

As shown in FIGS. 16A-C, the locking mechanism 450 can include a locking bracket 470 carried by the second portion, the locking bracket operable to move the lock tab 460 from the locked position to the unlocked position in response to the second portion being moved to its lowest position relative to the first portion. In such embodiments, independently adjusting the second portion to its lowest position causes interference, as shown by comparison of FIGS. 16A and 16B, between the locking bracket 470 and a lock component 480 that includes the lock tab 460 to cause the lock tab 460 to move against a biasing force (e.g., provided by biasing spring 464) to its unlocked position, as shown in FIG. 16C, thereby allowing the angle of the riser with respect to the base to be adjusted.

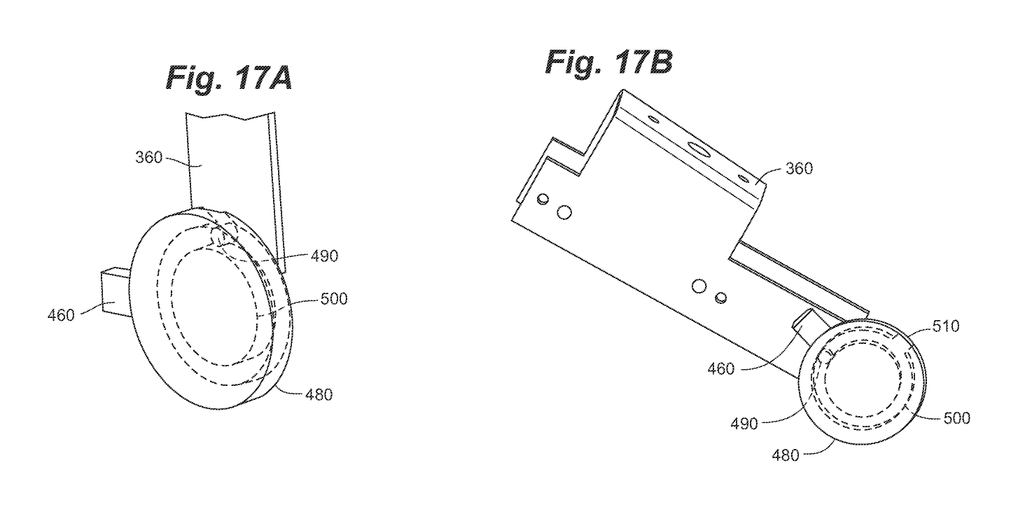

As shown in FIGS. 17A-B, in certain embodiments the locking mechanism includes a locking pin 490 that fixes the position of the first portion 450 with respect to the second portion 460 when in a locked position, and allows the first portion to move relative to the second portion when in the unlocked position. In such embodiments, the lock component 480 can include a circular slot 500 that allows the locking pin 490 to rotate when in the locked position to allow angular adjustment of the riser 30 in the locked position. As shown, the locking pin can only enter the circular slot through an entry slot 510 when the riser is in a generally vertical position.

Accordingly, embodiments of the locking mechanism are operable to prohibit independent adjustment of the second portion of the mounting bracket 40 with respect to the first portion of the mounting bracket 40 when the riser 30 is in a reclined position (e.g., any position other than its most vertical position), and is also operable to prohibit recline adjustment when the riser is in the generally vertical position unless the second portion is independently adjusted to a specific location with respect to the first portion (e.g., its lowermost position).

In use, a user can grasp an electronic display supported by the stand to change the angle and position of the electronic display relative to the base of the stand. The forces applied by the user will be transmitted to the riser via the mounting bracket. The user may also directly apply a force to the riser. In either case, the force will adjust the angle of the riser and will cause the mounting bracket to mover with respect to the riser and the sliding bracket to move with respect to the base via the movement of the first and second links and rotation about the first, second, third, and fourth pivots. In embodiments including an independent adjustment of the electronic display, the user can also independently adjust the height of the electronic display with respect to the riser, such as when the riser is in the generally vertical position, optionally by locking and unlocking a locking mechanism.

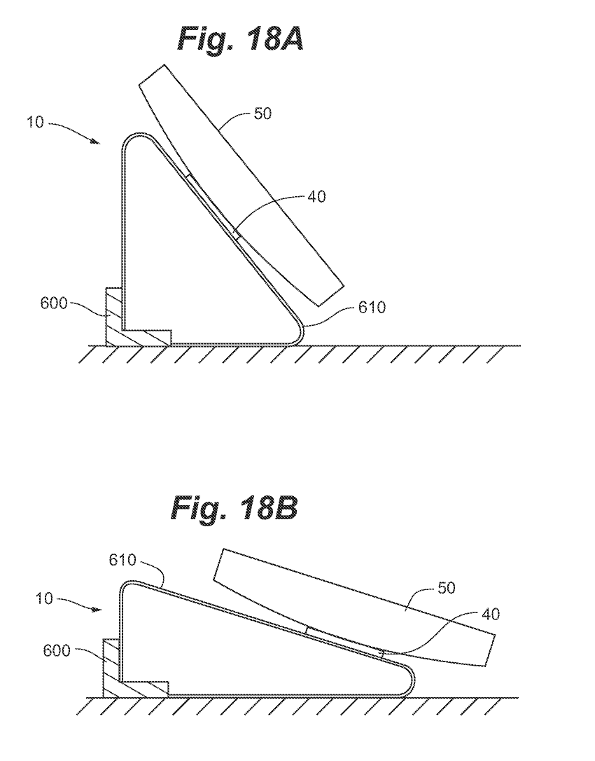

A third embodiment of a stand 10 in accordance with the invention is shown in FIGS. 18A-23B. FIG. 18A shows the stand 10 supporting an electronic display 50 in a generally vertical position and FIG. 18B shows the stand 10 supporting an electronic display in a generally reclined position. As shown, the electronic display moves towards the user as it is adjusted to its reclined position. In the embodiment shown, the stand includes a support element 600, at least one strip of deformable material 610 coupled to the support element 600, and a mounting bracket 40 coupled to the at least one strip of deformable material 610. In such embodiments, a user can adjust the position of an electronic display supported by the stand from a generally vertical position to a generally reclined position, and any intermediate position between these two positions, by deforming the strip of deformable material.

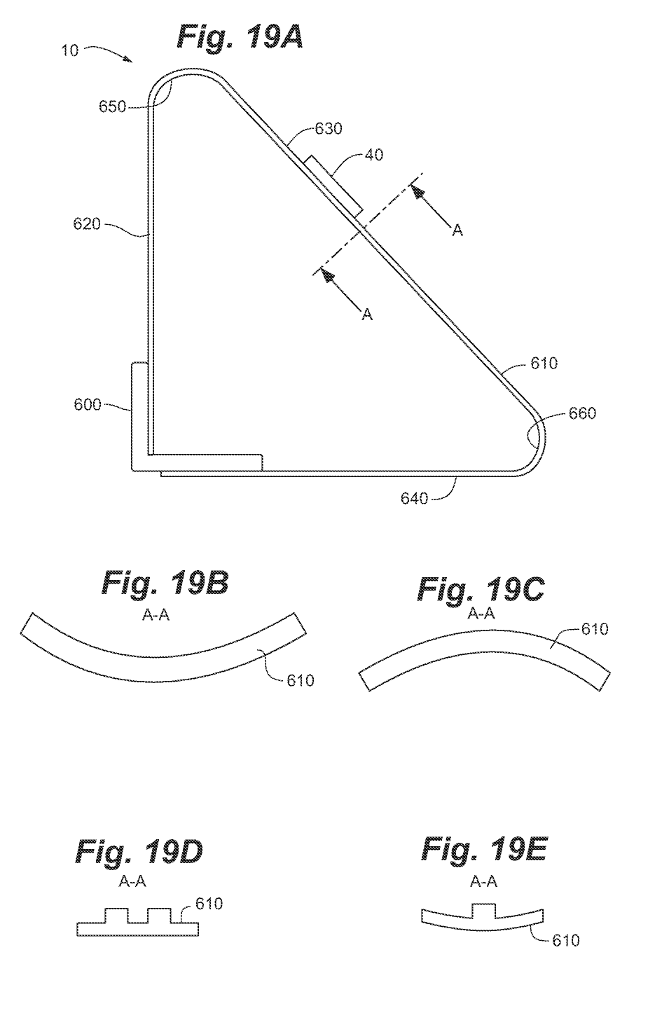

The at least one strip of deformable material 610 can include any material useful for supporting the electronic display as described above. In some embodiments, the at least one strip of deformable material includes a material selected from a group consisting of a metal (e.g., low carbon steel or stainless steel) and a polymer (e.g., polyurethane or nylon). In certain embodiments, the at least one strip of deformable material has a thickness of between about 0.25 millimeters to about 1 millimeter, and a width of between about and about 10 millimeters to about 50 millimeters. Further, the at least one strip of deformable material can include any useful cross-sectional shape. Exemplary embodiments of cross section A-A depicted in FIG. 19A are shown in FIGS. 19B-E. As shown, in some embodiments the cross-sectional shape is asymmetrical. Further, as shown, some cross-sectional shapes have a thickness that varies along the length of the strip of deformable material, such as in a repeating manner.

The support element 600 can include any structure useful for supporting and positioning the at least one strip of deformable material 610. In some embodiments, as shown in FIGS. 18A-19A, the support element includes a corner bracket having a right angle coupled to the strip of deformable material. The support element is generally more resilient than the strip of deformable material, and is useful for helping the strip of deformable material hold an assumed shape.

The at least one strip of deformable material 610 can be configured into any useful shape. As shown in FIG. 19A, the at least one strip of deformable material 610 can include a generally vertical portion 620, a generally inclined portion 630, and a generally horizontal portion 640, and a first bend 650 between the generally vertical portion and the generally inclined portion and a second bend 660 between the generally horizontal portion and the generally inclined portion. Note the location of these features will change as the stand is angularly adjusted. For example, a portion of the generally vertical portion may become the first bend, and the previous first bend may become part of the generally inclined portion as the stand is reclined.

A mounting bracket 40 can be coupled to the generally inclined portion 630. In some embodiments, the at least one strip of deformable material 610 is a continuous loop of deformable material attached to the support element 600. In other embodiments, the at least one strip of deformable material is a linear strip bent and coupled to the support element at two locations.

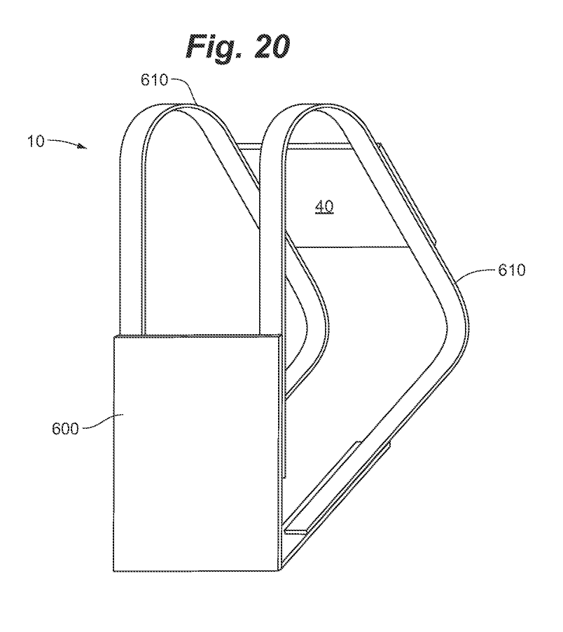

As shown in FIG. 20, some embodiments include a second strip of deformable material 610 coupled to the support element 600 and the mounting bracket 40. As shown, the at least one strip of deformable material and the second strip of deformable material can be parallel, and the mounting bracket can bridge them and be attached to both. Such embodiments may be useful for increasing the stability of the stand.

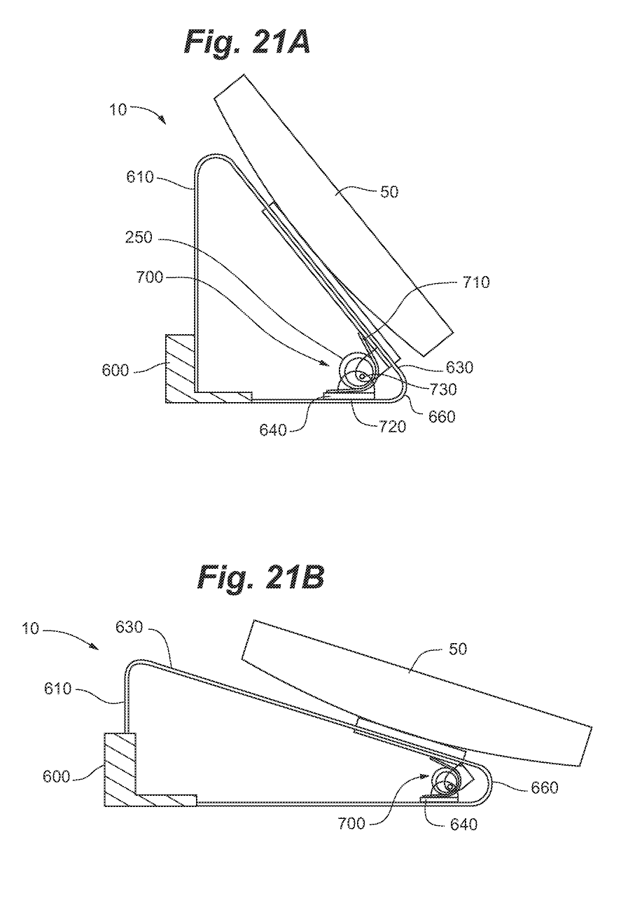

Some embodiments of the stand 10 are provided with additional positioning elements useful for adjusting the recline angle of the electronic display and/or maintaining an adjusted recline angle. As shown in FIGS. 21A-B, some embodiments include a hinge 700 proximate the second bend 660, the hinge having a first hinge bracket 710 acting against the generally inclined portion 630 and a second hinge bracket 720 acting against the generally horizontal portion 640, the first and second hinge brackets pivoting about a hinge axle 730, and a spring (e.g., torsion spring) 250 wound about the hinge axle and having a first end acting on the first hinge bracket and a second end acting on the second hinge bracket. FIG. 21A shows this embodiment in a generally vertical position, and FIG. 21B shows this embodiment in a generally reclined position.

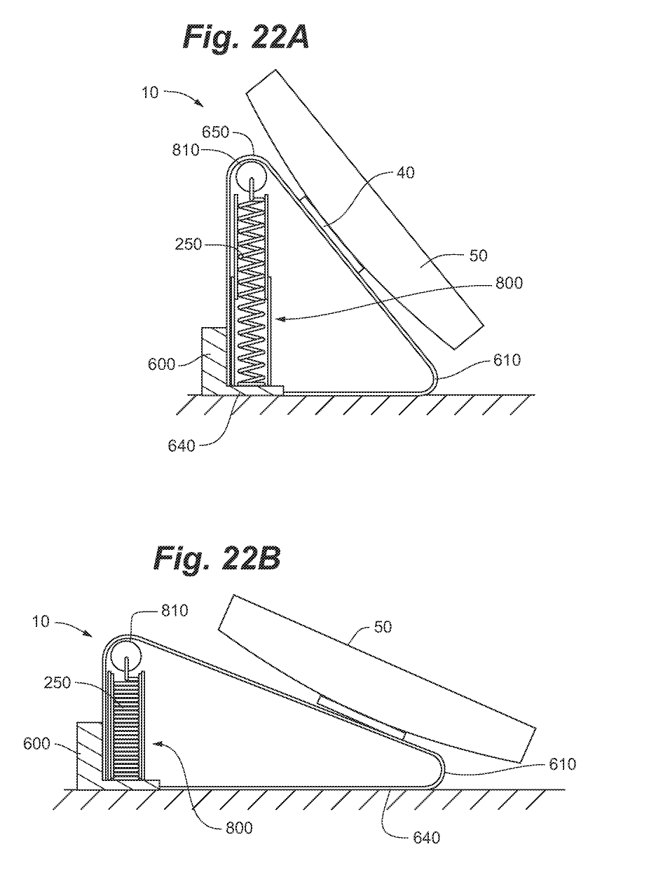

In other embodiments, as shown in FIGS. 22A-B, the stand 10 includes a telescoping bracket 800 positioned within the strip of deformable material 610. The telescoping bracket can include a fixed portion, optionally attached to the horizontal portion 640 and a movable portion movable with respect to the fixed portion. The movable portion can carry a rotatable member 810 adapted to interact with the strip of deformable material 610 proximate the first bend 650. Further, a spring (e.g., a compression spring) 250 can be included having a fixed end and a movable end, the movable end operatively coupled to the movable portion of the telescoping bracket. Such an embodiment is useful for providing balancing forces to hold a position of the stand. FIG. 22A shows this embodiment in a generally vertical position, and FIG. 22B shows this embodiment in a generally reclined position.

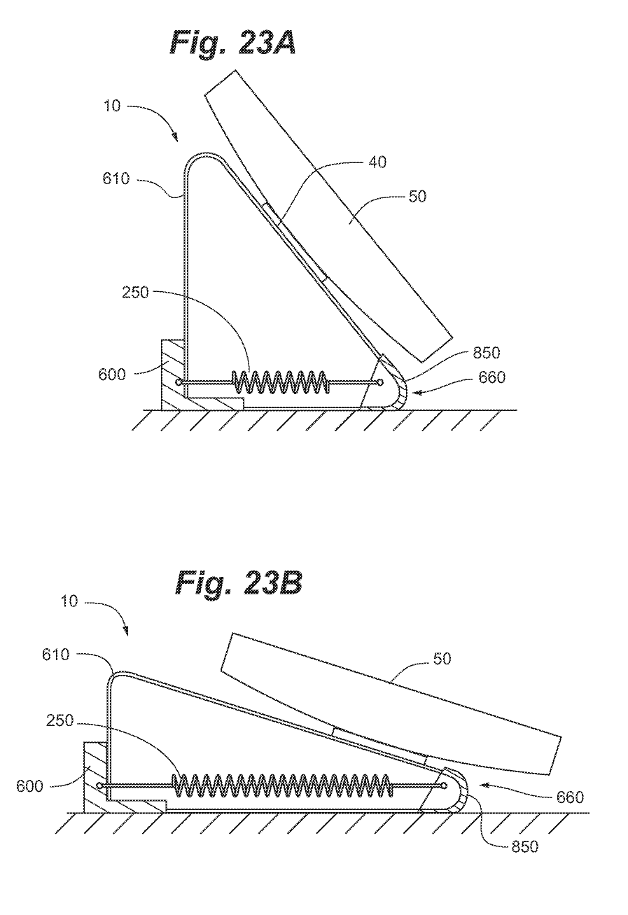

In yet other embodiments, as shown in FIGS. 23A-B, the stand 10 includes a spring (e.g., extension spring) 250 having a first end coupled to the support element 600 and a second end coupled to the at least one strip of deformable material 610 proximate the second bend 660. In some embodiments, the second end of the extension spring is coupled to a bend bracket 850 associated with the second bend. The bend bracket is useful for increasing the rigidity of the strip at the second bend. Such an embodiment is useful for providing balancing forces to hold a position of the stand. FIG. 23A shows this embodiment in a generally vertical position, and FIG. 23B shows this embodiment in a generally reclined position.

In use, a user can grasp an electronic display supported by the stand to change the angle and position of the electronic display relative to the base of the stand. The forces applied by the user will deform the strip of deformable material to reposition the electronic display.

In the foregoing detailed description, the invention has been described with reference to specific embodiments. However, it may be appreciated that various modifications and changes can be made without departing from the scope of the invention as set forth in the appended claims.

What is claimed is:

1. A stand for an electronic display, comprising:
a base adapted to rest on a horizontal surface;
a riser supporting a mounting bracket adapted to support the electronic display;
a first link having a first end pivotably coupled to the base at a first pivot and a second end pivotably coupled to the mounting bracket at a second pivot;
a second link having a first end pivotably coupled to a sliding bracket at a third pivot and a second end pivotably coupled to the first link at a fourth pivot, the sliding bracket being slidable with respect to the base,
wherein the riser is angularly adjustable with respect to the base from a generally vertical position to a generally reclined position and the mounting bracket moves along a length of the riser in response to an angular adjustment; and
at least one spring positioned to balance a torque that is applied to the riser by the electronic display at the generally vertical position, the generally reclined position, and any angle between the generally vertical position and the generally reclined position.

2. The stand of claim 1, wherein the at least one spring is a torsion spring operable about at least one of the first pivot, second pivot, third pivot, and fourth pivot.

3. The stand of claim 1, wherein the at least one spring includes a first spring operable about the second pivot and a second spring operable about the third pivot.

4. The stand of claim 3, wherein the first spring and the second spring are torsion springs.

5. The stand of claim 1, wherein the mounting bracket includes at least one mounting bracket pin received within a riser slot defined by the riser.

6. The stand of claim 1, wherein the sliding bracket includes at least one sliding bracket pin that slides within a base slot defined by the base.

7. The stand of claim 1, wherein the at least one spring includes a first end coupled to the base and a second end coupled to the sliding bracket.

8. The stand of claim 1, wherein the at least one spring includes a first spring operable about the third pivot and a second spring having a first end coupled to the base and a second end coupled to the sliding bracket.

9. The stand of claim 8, wherein the first spring is a torsion spring and the second spring is an extension spring.

10. The stand of claim 1, wherein the mounting bracket is coupled to the riser via at least one slide, the at least one slide having a first portion coupled to the mounting bracket and a second portion coupled to the riser, the first and second portions being slidable with respect to each other.

11. The stand of claim 1, wherein the sliding bracket is coupled to the base via at least one slide, the at least one slide having a first portion coupled to the sliding bracket and a second portion coupled to the base, the first and second portions being slidable with respect to each other.

12. The stand of claim 1, wherein the mounting bracket includes a first portion coupled to the first link about the first pivot and a second portion independently adjustable with respect to the first portion, the second portion adapted to carry the electronic display.

13. The stand of claim 12, wherein a counterbalancing mechanism is connected between the first portion and the second portion.

14. The stand of claim 12, wherein the first portion is adjustable with respect to the second portion only when the riser is in a generally vertical position.

15. The stand of claim 12, wherein the first portion is pivotably connected to the first link about the first pivot via a locking system.

16. The stand of claim 15, wherein the locking mechanism includes a lock tab that fixes the position of the first link with respect to the riser when in a locked position, and allows the first link to pivot about the second pivot with respect to the riser when in the unlocked position.

17. The stand of claim 16, wherein the locked position corresponds to the generally vertical position.

18. The stand of claim 17, wherein the locking mechanism includes a locking bracket carried by the second portion, the locking bracket operable to move the lock tab from the locked position to the unlocked position in response to the second portion being moved to its lowest position relative to the first portion.

19. The stand of claim 16, wherein the locking mechanism includes a locking pin that fixes the position of the first portion with respect to the second portion when in a locked position, and allows the first portion to move relative to the second portion when in the unlocked position.

20. The stand of claim 19, wherein the locking pin is rotatable within a circular slot defined by a lock component when in the locked position.

21. The stand of claim 1, wherein a tablet holder is attached to the mounting bracket.

22. The stand of claim 1, wherein the first pivot is a fixed pivot.

23. The stand of claim 1, wherein the second pivot is movable along a length of the riser.

24. The stand of claim 1, wherein the electronic display includes a tablet computer.

25. A stand for an electronic display, comprising:
a support element;
at least one strip of deformable material coupled to the support element; and
a mounting bracket coupled to the at least one strip of deformable material.

26. The stand of claim 25, further including a second strip of deformable material coupled to the support element and the mounting bracket.

27. The stand of claim 26, wherein the at least one strip of deformable material and the second strip of deformable material are parallel.

28. The stand of claim 25, wherein the at least one strip of deformable material includes a material selected from a group consisting of a metal and a polymer.

29. The stand of claim 25, wherein the support element includes a corner bracket.

30. The stand of claim 25, wherein the at least one strip of deformable material includes a generally vertical portion, a generally inclined portion, and a generally horizontal portion, and a first bend between the generally vertical portion and the generally inclined portion and a second bend between the generally horizontal portion and the generally inclined portion, the mounting bracket coupled to the generally inclined portion.

31. The stand of claim 30, further including a hinge proximate the second bend, the hinge having a first hinge bracket acting against the generally inclined portion and a second hinge bracket acting against the generally horizontal portion, the first and second hinge brackets pivoting about a hinge axle, and a torsion spring wound about the hinge axle and having a first end acting on the first hinge bracket and a second end acting on the second hinge bracket.

32. The stand of claim 30, further including a telescoping bracket positioned within the strip of deformable material, the telescoping bracket including a fixed portion and a movable portion movable with respect to the fixed portion, the movable portion carrying a rotatable member adapted to interact with the strip of deformable material proximate the first bend, further including a spring having a fixed end and a movable end, the movable end operatively coupled to the movable portion of the telescoping bracket.

33. The stand of claim 32, further including an extension spring having a first end coupled to the support element and a second end coupled to the at least one strip of deformable material proximate the second bend.

34. The stand of claim 33, wherein the second end of the extension spring is coupled to a bend bracket associated with the second bend.
